(19) United States
(12) Patent Application Publication
(10) Pub. No.: US 2021/0382908 A1
(43) Pub. Date: Dec. 9, 2021

(54) DATASET INTEGRATION FOR A COMPUTING PLATFORM

(71) Applicant: Capital One Services, LLC, McLean, VA (US)

(72) Inventor: Srinivas Mupparapu, Plano, TX (US)

(21) Appl. No.: 16/896,965

(22) Filed: Jun. 9, 2020

(51) Int. Cl. G06F 16/25; G06F 16/2457; G06F 16/22; G06F 9/54; G06F 9/445

(52) U.S. Cl. CPC G06F 16/252; G06F 16/24573; G06F 9/44505; G06F 9/542; G06F 16/221

(57) ABSTRACT

Aspects described herein may relate to methods, systems, and apparatuses for integrating a dataset into a computing environment and for configuring a computing platform based on a change in a data storage service or a data storage device. The integration may be performed based on a data flow descriptor. The data flow descriptor may define how the data storage platform is to integrate the dataset into the computing environment. One or more data processes may be determined based on the data flow descriptor and the one or more data processes may be performed to integrate the dataset into the computing environment. The one or more data processes may be performed via one or more plugins or other types of add-on or enhancement. If there is a change in a data storage service or a data storage device, a new plugin may be configured or an existing plugin may be updated.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

There are numerous challenges to ensuring datasets are integrated into a computing environment for storage and/or later access. For example, the computing environment may include a computing platform. The computing platform may be configured to integrate a dataset into the computing environment based on, for example, one or more data storage services and one or more data storage devices. Each data storage service and each data storage device may perform various functions associated with the storage or processing of datasets. As some examples, one data storage service or data storage device may be configured to transform or otherwise prepare a dataset for storage in a database, and another data storage service or data storage device may be configured as the database. Over time, however, these data storage services and data storage devices may change. Changes to the data storage services and data storage devices may occur to, as some examples, add or remove support for formats of datasets; add or remove support for different formats of databases; and/or update, add, or remove support for data services or data storage devices. To configure a computing platform based on a change to a data storage service or device, an entirety of one or more applications being executed by the computing platform may need to be updated, packaged, and deployed. The need to update, package, and deploy an entirety of the one or more applications may increase the time for developing, testing, and releasing the change to a data storage service or data storage device to undesirable levels. Further, the need to update, package, and deploy an entirety of the one or more applications may increase the complexity of developing, testing, and releasing the change to a data storage service or data storage device to undesirable levels. Even further, a number of existing products that provide a computing platform for integrating datasets may not be suitable for the customized needs of an enterprise's computing environment.

### SUMMARY

The following presents a simplified summary of various aspects described herein. This summary is not an extensive overview, and is not intended to identify key or critical elements or to delineate the scope of any claim. The following summary merely presents some concepts in a simplified form as an introductory prelude to the more detailed description provided below.

Aspects described herein may address one or more inadequacies of dataset integration, dataset processing, and/or configuring a computing platform based on a change to a data storage service or data storage device. Further, aspects described herein may address one or more other problems, and may generally improve systems that perform dataset integration, dataset processing, and/or configuration of a computing platform based on a change to a data storage service or device.

For example, aspects described herein may relate to integrating a dataset into a computing environment. For example, a computing platform may receive a notification that a dataset is to be integrated into the computing environment. The computing platform may generate and execute a script that causes integration of the dataset. Based on execution of the script, the computing platform may retrieve a data flow descriptor for the data set and may determine, based on the data flow descriptor, one or more data processes to perform. The computing platform may perform the one or more processes to integrate the dataset into the computing environment. The data flow descriptor may include or otherwise indicate one or more associations between the dataset and particular data storage services or data storage devices. The one or more data processes may be performed via one or more plugins.

Additional aspects described herein may relate to configuring a computing platform based on a change in a data storage service or a data storage device. For example, a data storage service or a data storage device that is to be added to or updated in the computing environment may be configured. Based on this configuring of the data storage service or the data storage device, a computing platform may receive data that includes code for performing one or more data processes associated with the data storage service or the data storage device. Based on the data, one or more plugins, or other type of add-on or enhancement, to the computing platform's data integration software may be configured. Thereafter, the one or more data processes associated with the data storage service or the data storage device may be performed via the one or more plugins.

These features, along with many others, are discussed in greater detail below. Corresponding apparatus, systems, and computer-readable media are also within the scope of the disclosure.

### BRIEF DESCRIPTION OF THE DRAWINGS

The present disclosure is illustrated by way of example and not limited in the accompanying figures in which like reference numerals indicate similar elements and in which:

FIG. 1 depicts a block diagram of an example computing environment that may be configured to integrate a dataset based on a computing platform according to various aspects described herein.

FIG. 2 depicts a block diagram of an example computing environment that may be configured to integrate a dataset based on an arrangement of computing devices that are configured according to one or more aspects described herein.

FIG. 3 depicts an example method that may integrate a dataset based on a computing platform according to various aspects described herein.

FIG. 4 depicts an example method that may configure a computing platform to perform one or more data processes associated with integrating a dataset.

FIG. 5 depicts an example of a computing device that may be used in implementing one or more aspects described herein.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

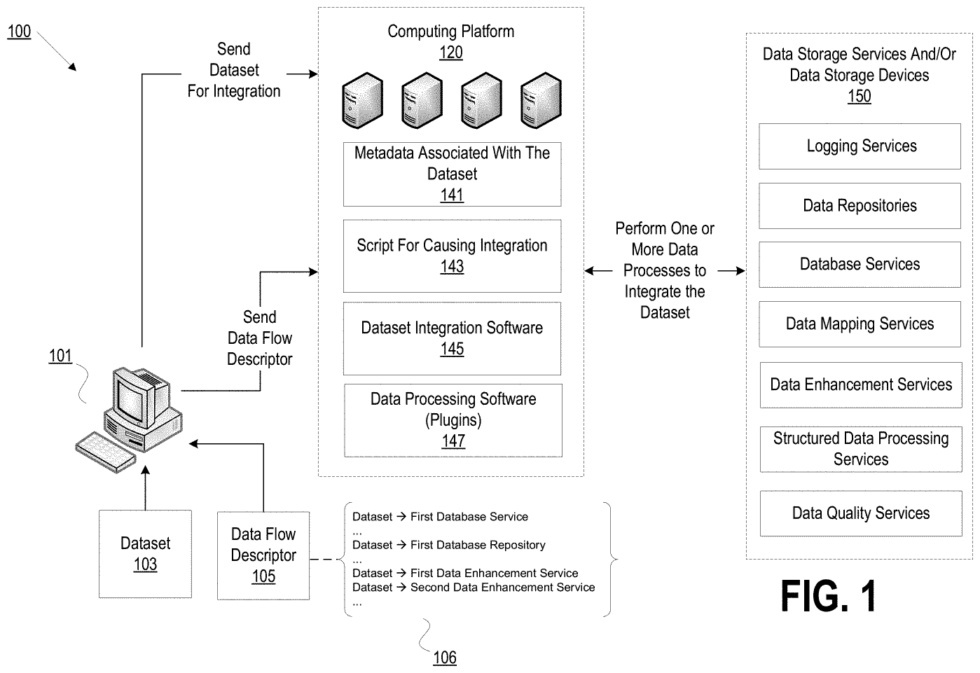

By way of introduction, aspects discussed herein may relate to methods and techniques for integrating a dataset into a computing environment. In connection with integrating a dataset into the computing environment, additional aspects discussed herein may relate to methods and techniques for configuring a computing platform based on a change in a data storage service or a data storage device. As a general introduction, a computing platform may be configured to perform various data processes when integrating a dataset into the computing environment. The data processes may perform one or more functions associated with any data storage service or data storage device that is configured within the computing environment. For example, the one or more functions may include data mapping, data transformations, data enhancements, data quality services, storing to a data repository, and the like. When a dataset is to be integrated into the computing environment, a data flow descriptor may be received that includes one or more associations between the dataset and the one or more data processes. The data flow descriptor, based on the one or more associations, may define how the computing platform is to integrate the dataset into the computing environment. For example, the data flow descriptor may include a first association that indicates the dataset, or a portion thereof, is to be stored to a data repository when integrating the dataset. The dataflow descriptor may include a second association that indicates a particular data mapping, data transformation, or data quality service to perform when integrating the dataset. Accordingly, when the computing platform is to integrate the dataset, the data flow descriptor may be read to determine, based on any association within the data flow descriptor, which data processes to perform. Based on this determination, the computing platform may, as part of integrating the dataset into the computing environment, perform one or more data processes, which may, among other things, map the dataset, transform the dataset, enhance the dataset, monitor the dataset for data quality, and store one or more portions of the dataset to a data repository. Additional examples of these aspects, and others, will be discussed below in connection with FIGS. 1-5.

Based on methods and techniques described herein, dataset integration may be improved. As one example, an improvement relates to the automation of dataset integration. The dataflow descriptor allows for the computing platform to automatically integrate a dataset after receiving the dataset and the dataflow descriptor for the dataset. The dataflow descriptor may have been authored for the dataset and, as described above, may define how the computing platform is to integrate the dataset into the computing environment. In this way, the computing platform may automatically integrate the dataset in the manner defined by the dataflow descriptor. During the integration process, no user input may be needed. As another example, an improvement relates to configuring the computing platform based on a change to a data storage service or a data storage device. If a new data storage service or new data storage device is added to or changed within the computing environment, the computing platform may be configured to add new data processes or update a subset of currently configured data processes. As will be described below, the data processes may not be compiled as part of the dataset integration software of the computing platform. Instead, the data processes may be performed based on plugins, or other type of add-on or enhancement to the dataset integration software. This may avoid the need to redeploy an entirety of the dataset integration software when a change is made to a dataset storage service or a dataset storage device. Instead of redeploying the entirety of the dataset integration software, a new plugin may be added or an existing plugin may be updated. Additional improvements will be apparent based on the disclosure as a whole.

FIG. 1 depicts a block diagram of an example computing environment 100 that may be configured to integrate a dataset 103 based on a computing platform 120. The computing environment 100 may be an enterprise computing environment that, among other things, stores and manages the datasets for an enterprise. As a brief overview, the computing environment 100 is depicted as including a computing device 101, a dataset 103, a data flow descriptor 105, a computing platform 120, and various data storage services and data storage devices 150. The computing environment 100 may include additional components not depicted in FIG. 1 including, for example, additional data storage services, additional data storage devices, and/or additional computing devices. Further, a data storage service may be provided by one or more of the data storage devices, one or more computing devices that are not explicitly shown in FIG. 1, or a combination thereof. Computing device 101 is depicted as performing various functions that include receiving the dataset 103, receiving the data flow descriptor 105, sending the dataset 103 for integration to computing platform 120, and sending the data flow descriptor 105 to the computing platform 120. The computing device 101 is provided as an example. The functions could be performed by different computing devices. For example, a first computing device may send the dataset 103 for integration to the computing platform 120. A second computing device may enable a user to author the data flow descriptor 105 and may store the data flow descriptor 105 to a storage device. A third computing device (e.g., the storage device that stores the data flow descriptor) may send the data flow descriptor 105 to the computing platform 120. Further, the computing device 101 may be configured as, or associated with, a data repository of the computing environment.

The dataset 103 may be intended for integration into the computing environment. Integration into the computing environment 100 may include integrating the dataset 103 into one or more of the data storage services and/or data storage devices 150. The dataset 103 may include various types, and formats, of data or data records. For example, the dataset 103 may include numeric data, textual data, image data, audio data, and the like. The dataset 103 may be formatted in one or more columns or rows. Examples of datasets that may be formatted in one or more columns or rows include tabular data and spreadsheet data. More particularly, the dataset 103 may include, for example, customer record data, call log data, account information, chat log data, transaction data, loan servicing data, and the like.

The computing platform 120 may be configured to cause integration of the dataset 103 into the computing environment 101. As part of integrating the dataset 103, the computing platform 120 may cause or otherwise perform one or more data processes with one or more of the data storage services and/or data storage devices 150. As one example, the computing platform 120 may, as part of integrating dataset 103, cause the dataset 103 to be mapped by a data mapping service; cause the dataset 103 to be enhanced by a data enhancement service; cause the dataset 103 to be processed by a data quality service; and may cause the dataset 103 to be stored to a data repository.

As depicted in FIG. 1, the computing platform 120 may cause integration of the dataset 103 based on the data flow descriptor 105, metadata 141 associated with the dataset 103, a script 143 for causing the computing platform 120 to integrate the dataset 103, dataset integration software 145, and data processing software 147. The data flow descriptor 105 may describe how the dataset 103 is to be integrated into the computing environment. Accordingly, the data flow descriptor 105 may include one or more associations between the dataset 103 and one or more of the data storage services and/or data storage devices 150. A more detailed discussion of the data flow descriptor 105 follows the discussion of the data storage services and/or data storage devices 150.

The metadata 141 associated with the dataset 103 may include a description of the dataset 103. This description may indicate various properties of the dataset 103 including, for example, a format of the dataset. As more particular examples, the metadata 141 may indicate a number of columns for the dataset 103, a length of the dataset 103, and a type of the dataset 103 (e.g., structured data, unstructured data). The metadata 141 may be stored by a metadata registry (not shown in FIG. 1). Accordingly, the computing platform 120 may have retrieved the metadata 141 from the metadata registry.

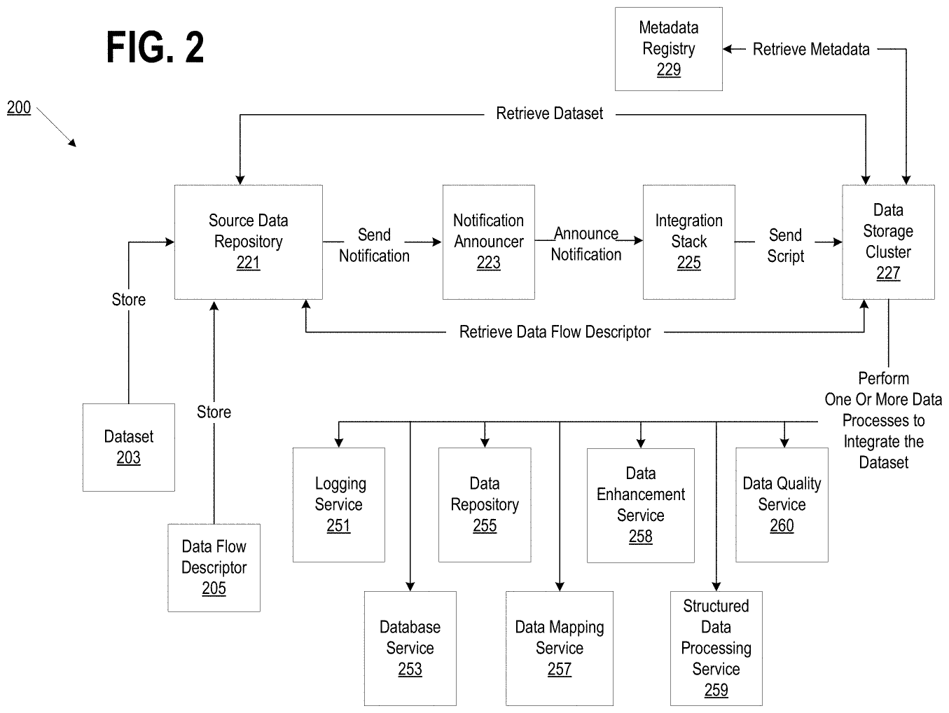

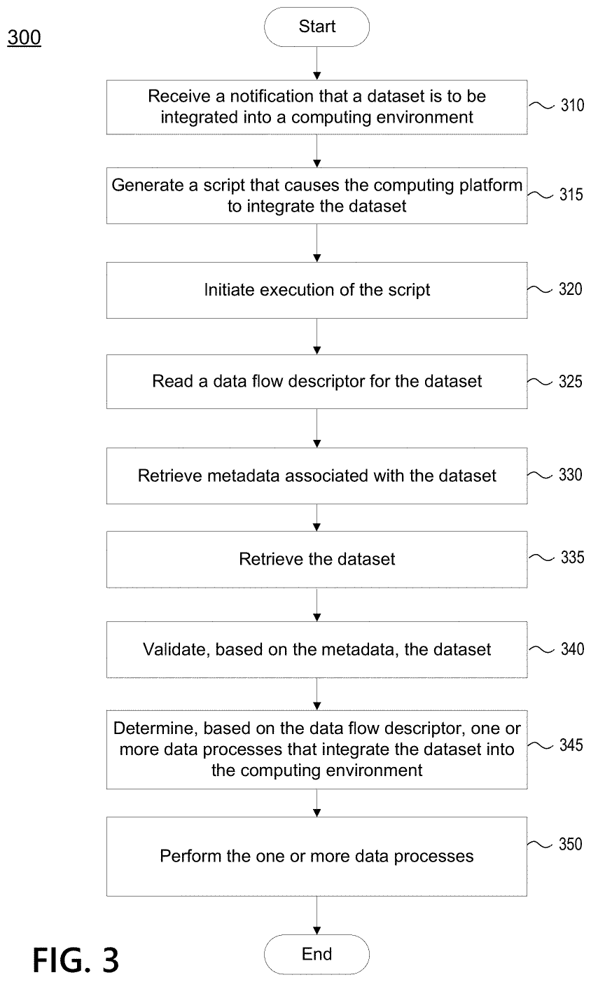

The script 143 may define a process flow that the computing platform 120 will perform when integrating a dataset. For example, the script 143, when executed by the computing platform 120, may cause the computing platform 120 to read the data flow descriptor 105, retrieve the metadata 141 associated with the dataset 103, validate the dataset 103, determine one or more data processes that integrate the dataset 103 into the computing environment 100, and cause performance of the one or more data processes. The script 143 may also include an identifier for the dataset 103 and location information that indicates a storage location of the dataset 103. Further details of the script 143 are discussed in connection with FIGS. 2 and 3.

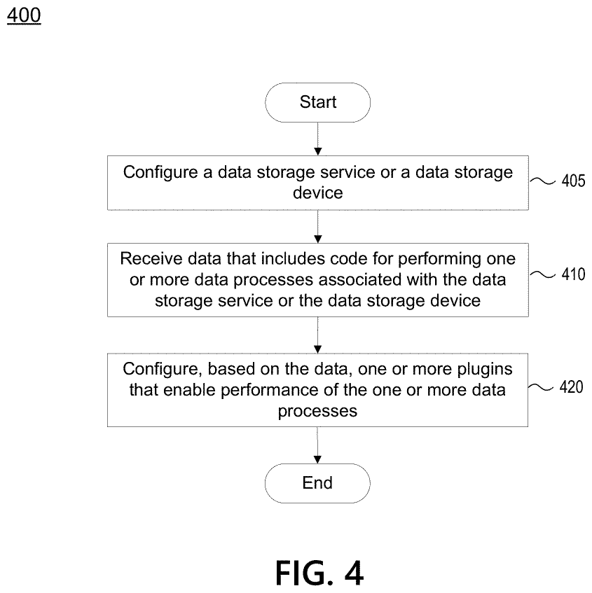

The dataset integration software 145 may provide a baseline data integration functionality for the computing platform 120. The data processing software 147 may be configured as plugins, or other type of add-on or enhancement to the dataset integration software 145. This arrangement may avoid the need to redeploy an entirety of the dataset integration software 145 when a change is made to the dataset storage services and/or the dataset storage devices 150. Instead of redeploying the entirety of the dataset integration software 145, a new plugin may be added or an existing plugin may be updated. FIG. 4 provides an example method that can be used to add a new plugin or update an existing plugin.

The data processing software 147 may enable the computing platform 120 to perform any data processes with the data storage services and/or data storage devices 150. For example, the data processing software 147 may include a plugin, or other type of add-on or enhancement to the dataset integration software 145, for each of the data storage services and/or each data storage devices 150. For simplicity, the examples throughout this disclosure will refer to the data processing software 147 as plugins. Further, many of the examples throughout this disclosure will refer to the plugins as including classes of an object-oriented programming language.

Additionally, the computing platform 120 is depicted in FIG. 1 as including a plurality of computing devices (e.g., the four devices depicted as part of the computing platform 120). These plurality of computing devices may be configured to perform the functions of the computing platform 120. An example arrangement of the plurality of computing devices is provided in connection with FIG. 2.

The data storage services and/or data storage devices 150 are depicted in FIG. 1 as including a number of examples services and/or devices. In particular, the depicted examples include one or more logging services, one or more data repositories, one or more database services, one or more data mapping services, one or more data enhancement services, one or more structured data processing services, and one or more data quality services. The computing platform may communicate with these services and/or devices when performing a data process to integrate a dataset (e.g., based on execution of the data processing software 147). Additionally, computing platform 120 may communicate with these services and/or devices based on the script 143. The depicted and below-discussed examples of data storage services and/or data storage devices 150 are not exhaustive, and a computing environment may include additional or alternative data storage services and/or data storage devices.

A logging service may provide an interface through which events associated with the computing environment 100 are recorded. The computing platform 120 may cause a data process to be performed with the logging service to record information indicative of the integration and/or to record information indicative of a result of another data process (e.g., record the result of a data validation). The computing platform 120 may, based on execution of the script 143, communicate with the logging service to record information indicative of the integration (e.g., a timestamp for the integration; an identifier of the dataset 103).

A data repository may provide one or more locations for data storage. A data repository may allow unstructured and/or structured data to be stored. A data repository may be configured to allow access to the stored data and/or for analytics to be performed on the stored data. A data repository may refer to a data lake, a data warehouse, or some other type storage location. The computing platform 120 may cause a data process to be performed with the data repository to store the dataset 103, or a portion thereof, and/or to store other data based on the integration of the dataset 103.

A database service may provide access to a database that is managed via a separate cloud, or virtualized, computing platform. A database service may be referred to as a Database as a Service (DBaaS). An example of a database service includes AMAZON REDSHIFT. Some technologies may be interchangeably referred to as a data repository and a database service. For example, a SNOWFLAKE data warehouse may be referred to as a data repository in view of it being a data warehouse and may be referred to as a database service in view of it being cloud-based. The computing platform 120 may cause a data process to be performed with the database service to store the dataset 103, or a portion thereof, and/or to store other data based on the integration of the dataset 103.

A data mapping service may establish relationships between different formats or data models. An example of data mapping may include identifying the current format of the dataset 103 and the data format of a destination storage location (e.g., a data repository or database service). The mapping service may manage the transformation of the dataset 103 between the two formats to ensure accuracy and usability once stored at the destination storage location. The computing platform 120 may cause a data process to be performed with the mapping service to map the dataset 103 based on a destination storage location. In some instances, the data process with the data mapping service may be performed prior to the dataset 103 being stored in a data repository or database service.

A data enhancement service may analyze the dataset 103 and modify the dataset 103 based on the analysis. An example enhancement service may analyze the dataset 103 to identify one or more blank fields within the dataset 103 and may fill in the one or more blank fields based on rules of the data enhancement service. The computing platform 120 may cause a data process to be performed with the data enhancement service to enhance the dataset 103. In some instances, the data process with the data enhancement service may be performed prior to the dataset 103 being stored in a data repository or database service.

A structured data processing service may transform or otherwise process the dataset 103 based on a structured data technology. An example of a structured data processing service is SPARK SQL (where SQL is an acronym for Structured Query Language). The computing platform 120 may cause a data process to be performed with the structured data processing service to transform or otherwise process the dataset 103 according to a particular structured data technology. In some instances, the data process with structured data processing service may be performed prior to the dataset 103 being stored in a data repository or database service.

A data quality service may process the dataset 103 to determine a knowledge base about the dataset 103. The knowledge base may be used to perform various tasks including, for example, correction, enhancement, standardization, and de-duplication. The data quality tasks may be performed by the data quality service or some other component of the computing environment (e.g., a data enhancement service). The computing platform 120 may cause a data process to be performed with the data quality service to process the dataset 103, determine a knowledge base about the dataset 103, and/or perform one or more data quality tasks. In some instances, the data process with data quality service may be performed prior to the dataset 103 being stored in a data repository or database service.

As discussed above in connection with the computing platform 120, the dataset 103 may be integrated based on the data flow descriptor 105. The data flow descriptor 105 may describe how the dataset 103 is to be integrated into the computing environment. Accordingly, the data flow descriptor 105 may include one or more associations between the dataset 103 and one or more of the data storage services and/or data storage devices 150. Based on the data flow descriptor, the computing platform 120 may perform one or more data processes with the data storage services and/or the data storage devices 150. The data flow descriptor may be authored by a user.

FIG. 1 depicts a generalized example 106 of a dataflow descriptor 105. The generalized example 106 indicates that the data flow descriptor 105 may include a plurality of associations. More particularly, the generalized example 106 indicates that the data flow descriptor 105 includes an association between the dataset 103 and a first database service. This association may indicate that the dataset 103, or a portion thereof, is to be stored in the first database service. The generalized example 106 indicates that the data flow descriptor 105 includes an association between the dataset 103 and a first database repository. This association may indicate that the dataset 103, or a portion thereof, is to be stored in the first database repository. The generalized example 106 indicates that the data flow descriptor 105 includes an association between the dataset 103 and a first data enhancement service. This association may indicate that the dataset 103 is to be processed by the first data enhancement service. The generalized example 106 indicates that the data flow descriptor 105 includes an association between the dataset 103 and a second data enhancement service. This association may indicate that the dataset 103 is to be processed by the second data enhancement service. Based on the generalized example 106, the computing platform 120 may perform at least four data processes when integrating the dataset 103: a first data process with the first database service; a second data process with the first database repository; a third data process with the first enhancement service; and a fourth data process with the second enhancement service.

Table I illustrates a more detailed example of a data flow descriptor 105. In particular, Table I indicates an example of a data flow descriptor that has been authored using JavaScript Object Notation (JSON) and identifies various classes associated with an object-oriented programming language. For each class, one or more properties of the dataset 103 may be defined as one or more parameters for the class. These classes may be found within a plugin of the computing platform 120. In this way, the computing platform 120, based on reading the data flow descriptor, will be able to determine which data processes to perform via the plugins. Accordingly, each section of the example data flow descriptor 105 that is associated with a particular class is an example of a data association between the dataset 103 and one or more of the data storage services and/or the data storage devices 150. The example data flow descriptor of Table I is shown in the second column of Table I. The example data flow descriptor of Table I is divided into different sections by separating each section based on row. The first column of Table I provides a brief description of the corresponding section. The example data flow descriptor of Table I may be a portion of a syntactically correct JSON file.

TABLE I
Example data flow descriptor

| Brief Description | Example Data Flow Descriptor |
|---|---|
| Header information for the data | { |

| | |
|---|---|
| flow descriptor. Includes, for | “header”: { |

| | |
|---|---|
| example, an identifier of the | “unique_id”: “call_records_init.gz”, |
| dataset 103, and information | “lob”: “COAF”, |
| associated with the source | “subject_area”: “D0”, |
| location at which the dataset | “true_source”: “dataset_source_data_lake”, |
| 103 is stored. | “interface_number”: “lake02”, |
| | “app_nm”: “coaf_fs_tellme”, |
| | “job_system”: “AROW”, |
| | “uses_generic_scheduler”: false, |
| | “prevent_default_workflow”: true, |
| | “job_name”: “JOBS.COAF. CALL _RECORDS_INIT_GZ” |

},

| | |
|---|---|
| Additional information for the | “dataset_information”: { |

| | |
|---|---|
| dataset 103. | “call_ records_init.gz”: { |

“registryPlatform”: “DATALAKE”,
“partition_path_regex”: “.*/.*/.*/.*/.*/(.{8}).*/.*”,
“partition_path_output_pattern”: “{1}”,
“instance_id_regex”: “.*/.*/.*/.*/.*/(.{8}).*/.*”,
“instance_id_output_pattern”: “{1}”

}

},

| | |
|---|---|
| Information indicating the | “registry_info”: { |

| | |
|---|---|
| metadata of the dataset 103 | “source_dataset”: { |

| | |
|---|---|
| and/or metadata registry that | “id”: { |

| | |
|---|---|
| stores the metadata of the | “qest”: “295669”, |
| dataset 103. | “prod”: “${0.datasetId}” |

}

},
“target_dataset”: {

“id”: {

“qest”: “295670”,
“prod”: “146232”

}

}

},

| | |
|---|---|
| A definition of any pre- | “pre_processing ”: [ ], |
| processing for the dataset 103. | |
| In this example, there are no | |
| associations identified as part of | |
| the pre-processing. | |
| The following three rows | |
| provide examples of | |
| associations between the dataset | |
| 103 and one or more data | |
| storage services and/or data | |
| storage devices. | |
| The column to the right of this | |
| row is intentionally being left | |
| blank. | |
| A first association of the | { |

| | |
|---|---|
| integration. This association | “process_name”: “input_1”, |
| identifies a class of a plugin for | “action_class”: “components.reader.InputReaderPlugin”, |
| performing a data process on a | “parameters”: { |

| | |
|---|---|
| data repository (e.g., a data read | “input_datasets”: [“${0.datasetName}”], |
| process). This association also | “output_datasets”: [“${0.datasetName}”] |

| | |
|---|---|
| identifies information | }, |
| associated with the dataset that | “conf”: { |

| | |
|---|---|
| will be passed as parameters to | “header”: false, |
| the class. Based on this | “trailer”: false, |
| association, the computing | “dataset_type”: “compressed_gzip_delimited”, |
| platform 120 may, via the | “exclusions”: { |

| | |
|---|---|
| plugin, cause a data process to | “excluded_files_regex”: |

| | |
|---|---|
| be performed that reads data | [“(.*)(.feature\|.properties)”] |

| | |
|---|---|
| from the data repository and/or | }, |
| stores the dataset 103 in the | “registry_info”: [{ |

| | |
|---|---|
| data repository. This data | “alias”: “source_dataset”, |
| process may involve reading | “data_lake”: { |

| | |
|---|---|
| and/or processing data registry | “category”: “Category3”, |
| information, which includes a | “environment”: “Lake”, |
| data scheme for a source | “classification”: “Source” |

| | |
|---|---|
| dataset. The data registry | } |

| | |
|---|---|
| information may be included in | }] |

| | |
|---|---|
| the “registry_info” section of | } |

| | |
|---|---|
| this example data flow | }, |

| | |
|---|---|
| descriptor, which is shown in an | |
| above row. | |
| A second association of the | { |

| | |
|---|---|
| integration. This association | “process_name”: “data_quality”, |
| identifies a class of a plugin for | “action_class”: “dq.adapter.DQAdapter”, |
| performing a data process with | “parameters”: { |

| | |
|---|---|
| a data quality service. This | “input_datasets”: [“${0.datasetName}”], |
| association also identifies | “output_datasets”: [“${0.datasetName}_adq_vldtd”] |

| | |
|---|---|
| information associated with the | }, |
| dataset that will be passed as | “conf”: { |

| | |
|---|---|
| parameters to the class. Based | “outputFiles”: { |

| | |
|---|---|
| on this association, the | “dataSetName”: |

| | |
|---|---|
| computing platform 120 may, | “card_call_detail_records_init.parquet”, |

| | |
|---|---|
| via the plugin, cause a data | “outputInstanceId”: “${output_instance_id}”, |
| process to be performed that | “type”: “rdd”, |
| processes the dataset 103 via | “ruleRejects”: { |

| | |
|---|---|
| the data quality service. | “dataSetName”: “${0.datasetName}”, |
| | “ruleRejectsThreshold”: 0, |
| | “includeRejects”: false |

}

},
“rowCountValidations”: {

“headers”: {

“rowCount”: false

},
“trailers”: {

“trailerSchema”: “,\u00262”,
“rowCount”: true

}

},
“registry_info”: [{

“registryInfold”: “1”,
“alias”: “source_dataset”,
“one_lake”: {

“category”: “Category3”,
“environment”: “Lake”,
“classification”: “Source”

}

}, {

“registryInfold”: “2”,
“alias”: “source_dataset”,
“data_lake”: {

“category”: “Category3”,
“environment”: “Lake”,
“classification”: “Dq”

}

}],
“recordEndsOnNewLine”: false,
“ignoreDoubleQuotes”: false,
“removeMismatchQuotes”: true,
“largeZipFile”: false

}

},

| | |
|---|---|
| A third association of the | { |

| | |
|---|---|
| integration. This association | “process_name”: “validated_data_writer”, |
| identifies a class of a plugin for | “action_class”: “components.writer.OutputWriterPlugin”, |
| performing a data process with | “parameters”: { |

| | |
|---|---|
| a data repository. This | “input_datasets”: [“${0.datasetName}_adq_vldtd”], |
| association also identifies | “output_datasets”: [“${0.datasetName}_adq vldtd”] |

| | |
|---|---|
| information associated with the | }, |
| dataset that will be passed as | “conf”: { |

| | |
|---|---|
| parameters to the class. Based | “instanceId”: “${output_instance_id}”, |
| on this association, the | “registry_info”: [{ |

| | |
|---|---|
| computing platform 120 may, | “alias”: “target_dataset”, |
| via the plugin, cause a data | “data_lake”: { |

| | |
|---|---|
| process to be performed that | “category”: “Category3”, |
| updates the dataset 103 stored | “environment”: “Lake”, |
| in the data repository based on | “classification”: “Source” |

| | |
|---|---|
| the processing of the data | } |

| | |
|---|---|
| quality service. This ends the | }], |
| definition for the integration of | “overwrite_output”: true |

| | |
|---|---|
| the dataset 103. | } |

}],

| | |
|---|---|
| A definition of any post- | “post_processing_sequence”: [ ] |
| processing for the dataset 103. | } |
| In this example, there are no | |
| associations identified as part of | |
| the post-processing. This ends | |
| the example data flow | |
| descriptor. | |

In view of the example data flow descriptor of Table I, the computing platform 120 may integrate the dataset 103 by performing three data processes: a first data process that causes the dataset 103 to be stored in a data repository; a second data process that causes the dataset 103 to be processed via a data quality service; and a third data process that causes the data repository to update its copy of the dataset 103 based on the processing of the data quality service. Each data process may be performed by executing code via a corresponding plugin. Further, each data process may include instantiating a class that was identified via the corresponding data association of the data flow descriptor. This is only one example of the types of processes that can be performed when integrating the dataset 103. The integration may include any number or combination of processes associated with the data storage services and/or data storage devices 150.

FIG. 2 depicts a block diagram of an example computing environment 200 that may be configured to integrate a dataset 203 based on an arrangement of computing devices that are configured according to one or more aspects described herein. In particular, FIG. 2 provides additional details on an arrangement of devices that can be configured as the computing platform 120 of FIG. 1. As depicted in FIG. 2, the notification publisher 223, the integration stack 225, and the data storage cluster 227 may be configured to operate as the computing platform 120. Additionally, a number of components depicted in the computing environment 200 may be the same as, or similar to, those depicted in the computing environment 100 of FIG. 1. For example, dataset 203 may be the same as, or similar to, the dataset 103. The data flow descriptor 205 may be the same as, or similar to, the data flow descriptor 105. The logging service 251, the database service 253, the data repository 255, the data mapping service 257, the data enhancement service 258, the structured data processing service 259, and the data quality service 260 may the same as, or similar to the data storage services and/or data storage devices 150.

The notification publisher 223, the integration stack 225, and the data storage cluster 227, as arranged in FIG. 2, provide an example as to how the computing platform 120 may prepare to perform the integration of a dataset, perform the integration of the dataset, and communicate with other components of a computing environment in connection with the integration. The source data repository 221 and the metadata registry 229 are two examples of the other components of a computing environment.

As depicted in FIG. 2, the data flow descriptor 205 may be stored in a source data repository 221. The data flow descriptor 205 may have been authored to define how the dataset 203 is to be integrated into the computing environment 200. As also depicted in FIG. 2, the dataset 203 may be stored in the source data repository 221. The dataset 203 and the data flow descriptor 205 may be stored in different partitions of the source data repository 221. In some instances, the source data repository 221 may be the same as the data repository 255, which is to store the dataset 203 after integration. The dataset 203 may be stored in a first partition prior to integration. After the integration, the dataset 203 may be stored in a second partition different from the first partition.

The source data repository 221 may, based on the dataset 203 being stored, send a notification of the dataset 203 to the notification publisher 223. The notification may include an identifier for the dataset 203 and/or location information indicating a storage location of the dataset 203. The notification announcer 223 may be configured to manage the announcement of notifications to various end-points. As depicted in FIG. 2, the integration stack 225 may be one of those end-points. The integration stack 225 may be configured to listen for announcements from the notification announcer 223. Once the notification of the dataset 203 is received by the integration stack 225 via the announcement of the notification publisher 223, the integration stack 225 may generate a script for causing integration of the dataset 203. The script may be the same as, or similar to, the script 143 of FIG. 1. Further, the script may include the identifier for the dataset 203 and/or location information indicating a storage location of the dataset 203. After generating the script, the integration stack 225 may send the script to the data storage cluster 227 for execution. The notification announcer 223 may be implemented as part of a cloud-based notification service, such as AMAZON Simple Notification Service (SNS). The integration stack 225 may be implemented as part of a cloud-based computing service, such as AMAZON Web Service (AWS) Lambda.

The data storage cluster 227 may execute the script, which causes the dataset 203 to be integrated into the computing environment 200. For example, the script, when executed by the data storage cluster 227, may cause the data storage cluster 227 to, among other things, retrieve the dataset from the source data repository 221, retrieve the data flow descriptor 205 from source data repository 221, read the data flow descriptor 205, retrieve metadata associated with the dataset 203 from the metadata registry 229, determine one or more data processes that integrate the dataset 203 into the computing environment 200, and cause performance of the one or more data processes. The one or more data processes may be with one or more of the logging service 251, the database service 253, the data repository 255, the data mapping service 257, the data enhancement service 258, the structured data processing service 259, and the data quality service 260. For example, if the data flow descriptor 205 includes the associations of the example data flow descriptor of Table I, the data storage cluster 227 may perform a first data process that causes the dataset 203 to be stored in data repository 255, a second data process that causes the dataset 203 to be processed via the data quality service 260, and a third data process that causes the data repository 255 to update its copy of the dataset 203 based on the processing of the data quality service 260. The data storage cluster 227 may implement APACHE SPARK.

Having discussed the example computing environments 100 and 200 of FIGS. 1 and 2, example methods, which may be performed by one or more computing devices of the example computing environments 100 and 200, will be discussed. The example methods are depicted at FIGS. 3 and 4.

FIG. 3 depicts an example method that may integrate a dataset based on a computing platform according to various aspects described herein. Method 300 may be implemented by one or more suitable computing devices, as described herein. For example, method 300 may be implemented by one or more computing devices and/or one or more computing platforms (e.g., computing platform 120), as described in connection with computing environments 100 and 200. Method 300 may be implemented in suitable computer-executable instructions, such as in dataset integration software 527 and data processing software 529.

At step 310, the one or more computing devices and/or the one or more computing platforms may receive a notification that a dataset is to be integrated into a computing environment. The notification may be received, for example, from a data repository that stores the dataset (e.g., source data repository 221). The notification may include an identifier for the dataset 203 and/or location information indicating a storage location of the dataset 203.

At step 315, the one or more computing devices and/or the one or more computing platforms may generate a script that causes integration of the dataset into the computer environment. The script (e.g., script 143 of FIG. 1) may define a process flow that will be performed when integrating the dataset. For this example method 300, the process flow is represented by steps 325-350. The script may, based on the notification received at step 310, include an identifier for the dataset (e.g., “call_records_init.gz” as shown in Table I) and location information that indicates a storage location of the dataset (e.g., information indicating the source data repository 221 and/or a storage location within the source data repository 221).

At step 320, the one or more computing devices and/or the one or more computing platforms may initiate execution of the script. Once initiated, the process flow that is defined by the script is performed and, based on the execution, the dataset is integrated into the computing environment. The remaining steps of the example method 300, steps 325-350, provide an example of the process flow that is performed by the one or more computing devices and/or the one or more computing platforms based on execution of the script.

At step 325, the one or more computing devices and/or the one or more computing platforms may retrieve a data flow descriptor for the dataset. This data flow descriptor may have been authored for the dataset, and may describe how the dataset is to be integrated into the computing environment. Accordingly, the data flow descriptor may include one or more associations between the dataset and one or more of the computing environment's data storage services and/or data storage devices. An example of a data flow descriptor is provided in connection with FIG. 1 and at Table I. For purposes of this example method 300, the data flow descriptor will be discussed in terms of the example of Table I.

To retrieve the dataset, the may send a query based on the dataset. For example, the data flow descriptor may be stored in a common location for data flow descriptors (e.g., a particular partition in the source data repository 221). In this way, the one or more computing devices and/or the one or more computing platforms may query the common location using the identifier for the dataset. Any stored data flow descriptor may be compared to the identifier for the dataset. As shown in the example of Table I, the header information of a data flow descriptor may include an identifier for the dataset. Accordingly, if a match is found between the query's identifier and an identifier of a data flow descriptor's header information, the matching data flow descriptor may be sent to the one or more computing devices and/or the one or more computing platforms as a response to the query.

At step 330, the one or more computing devices and/or the one or more computing platforms may retrieve metadata associated with the dataset. The data flow descriptor may include information indicating the metadata associated with the dataset or information indicating the metadata registry where the metadata is stored. Accordingly, based on the data flow descriptor, the metadata associated with the dataset may be retrieved from the metadata registry.

At step 335, the one or more computing devices and/or the one or more computing platforms may retrieve the dataset. Based on the notification received step 310 and/or the data flow descriptor (e.g., as shown in the example of Table I, the header information of a data flow descriptor may include information associated with the source location at which the dataset 103 is stored), the dataset may be retrieved from the source data repository at which it is currently stored.

At step 340, the one or more computing devices and/or the one or more computing platforms may validate, based on the metadata, the dataset. The validation may be performed based on the description of the dataset that is included in the metadata. For example, the validation may be performed to validate that the dataset is in accordance with the metadata's indication of a format of the dataset. As more particular examples, the validation may be performed to validate that the dataset has a number of columns as indicated by the metadata, to validate that the dataset is equal to a length of the dataset as indicated by the metadata, and/or to validate that the dataset is equal to a type of the dataset as indicated by the metadata. The results of the validation may be sent to a logging service (e.g., logging service 251). If the validation passes, the method 300 may proceed to step 345. If the validation does not pass, the method 300 may end (not shown).

At step 345, the one or more computing devices and/or the one or more computing platforms may determine, based on the data flow descriptor, one or more data processes that integrate the dataset into the computing environment. This determination may be performed based on any associations between the dataset and a data storage service or data storage device, as defined or otherwise included in the data flow descriptor. For example, the example data flow descriptor of Table I includes three associations. Accordingly, based on three associations of the example data flow descriptor of Table I, three data processes may be determined: a first data process that causes the dataset to be stored in a data repository; a second data process that causes the dataset to be processed via a data quality service; and a third data process that causes the data repository to update its copy of the dataset based on the processing of the data quality service. Each of these three data processes may be performed via a plugin (e.g., data processing software 147) to dataset integration software implemented by the one or more computing devices and/or the one or more computing platforms. The three data processes are only examples. A data process determined at step 345 may be with any of the data storage services and/or devices of FIGS. 1 and 2 (e.g., services/devices 150 of FIG. 1 and/or services/devices 251-260 of FIG. 2).

The one or more data processes may be associated with an order in which they are to be performed. The one or more computing devices and/or the one or more computing platforms may determine the order based on the data flow descriptor. For example, with respect to the example data flow descriptor of Table I, the order is based on the sequence of the three associations. As another example, the data flow descriptor may include, for each association, a data field that indicates a sequence number for the association. The sequence numbers for the associations may indicate the order. In this way, the data processes may be performed based on the sequence numbers of the data flow descriptors. This determination of the order may be performed as part of the determination of the one or more data processes (e.g., the one or more data processes may be determined in a particular sequence so that they are performed in the particular sequence).

At step 350, the one or more computing devices and/or the one or more computing platforms may perform the one or more data processes. The one or more data processes may be performed via one or more plugins (e.g., data processing software 147). Accordingly, performing a data process may include executing code via a plugin. Further, performing a data process may include instantiating a class associated with an object-oriented programming language. Continuing the example of step 345 that is with respect to the example data flow descriptor of Table I, three data processes may be performed at step 350: a first data process that causes the dataset to be stored in a data repository; a second data process that causes the dataset to be processed via a data quality service; and a third data process that causes the data repository to update its copy of the dataset based on the processing of the data quality service. The three data processes are only examples. A data process performed at step 350 may be with any of the data storage services and/or devices of FIGS. 1 and 2 (e.g., services/devices 150 of FIG. 1 and/or services/devices 251-260 of FIG. 2).

FIG. 4 depicts an example method 400 that may configure one or more computing devices and/or one or more computing platforms to perform one or more data processes associated with integrating a dataset. Method 300 may be implemented by one or more suitable computing devices, as described herein. For example, method 400 may be implemented by one or more computing devices and/or one or more computing platforms (e.g., computing platform 120), as described in connection with computing environments 100 and 200. Method 400 may be implemented in suitable computer-executable instructions, such as in dataset integration software 527 and data processing software 529.

The example method 400 may be performed based on a change to a data storage service or a data storage device. For example, if a new data storage service or a new data storage device is to be added to the computing environment, the example method 400 may be performed. If a data storage service or a data storage device is to be updated, the example method 400 may be performed. By performing the example method 400, a new plugin may be added or an existing plugin may be updated (e.g., data processing software 147 may be added to or updated). This may avoid the need to redeploy an entirety of the dataset integration software when a change is made to a dataset storage service or a dataset storage device.

At step 405, the one or more computing devices and/or the one or more computing platforms may configure a data storage service or a data storage device. This configuring may including updating a data storage service or updating a data storage device. Alternatively, this configuring may include adding a new data storage service or adding a new data storage device to the computing environment. As a general example, the configuring may include adding or updating any of the data storage services and/or devices, including those depicted in FIGS. 1 and 2 (e.g., services/devices 150 of FIG. 1 and/or services/devices 251-260 of FIG. 2).

At step 410, the one or more computing devices and/or the one or more computing platforms may receive data that includes code for performing one or more data processes associated with the data storage service or the data storage device. The data may take the form of a Java ARchive (JAR) file. The JAR file may include code for each data process that can be performed with the data storage service or the data storage device. The code may be written in Java or other object-oriented programming language. The code may include one or more classes of the object-oriented programming language. A data flow descriptor may include information indicating any of the one or more classes and/or information indicating information that will be passed as parameters to any of the one or more classes (e.g., as discussed in connection with Table I).

At step 415, the one or more computing devices and/or the one or more computing platforms may configure, based on the data, one or more plugins that enable performance of the one or more data processes. The one or more plugins may be configured as extensions for dataset integration software (e.g., dataset integration software 145). Once configured, any of the data processes associated with the data storage service or the data storage device may be performed by executing code via the one or more plugins (e.g., as discussed in connection with step 350 of FIG. 3).

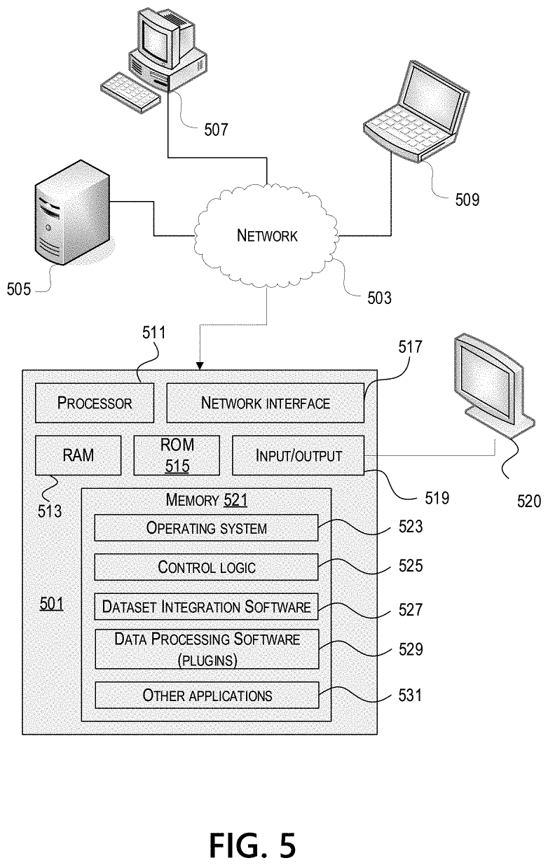

FIG. 5 illustrates one example of a computing device 501 that may be used to implement one or more illustrative aspects discussed herein. For example, computing device 501 may, in some embodiments, implement one or more aspects of the disclosure by reading and/or executing instructions and performing one or more actions based on the instructions. Computing device 501 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

Computing device 501 may, in some embodiments, operate in a standalone environment. In others, computing device 501 may operate in a networked environment. As shown in FIG. 5, various network nodes 501, 505, 507, and 509 may be interconnected via a network 503, such as the Internet. Other networks may also or alternatively be used, including private intranets, corporate networks, LANs, wireless networks, personal networks (PAN), and the like. Network 503 is for illustration purposes and may be replaced with fewer or additional computer networks. A local area network (LAN) may have one or more of any known LAN topology and may use one or more of a variety of different protocols, such as Ethernet. Devices 501, 505, 507, 509 and other devices (not shown) may be connected to one or more of the networks via twisted pair wires, coaxial cable, fiber optics, radio waves or other communication media.

As seen in FIG. 5, computing device 501 may include a processor 511, RAM 513, ROM 515, network interface 517, input/output interfaces 519 (e.g., keyboard, mouse, display, printer, etc.), and memory 521. Processor 511 may include one or more computer processing units (CPUs), graphical processing units (GPUs), and/or other processing units such as a processor adapted to perform computations associated with speech processing or other forms of machine learning. I/O 519 may include a variety of interface units and drives for reading, writing, displaying, and/or printing data or files. I/O 519 may be coupled with a display such as display 520. Memory 521 may store software for configuring computing device 501 into a special purpose computing device in order to perform one or more of the various functions discussed herein. Memory 521 may store operating system software 523 for controlling overall operation of computing device 501, control logic 525 for instructing computing device 501 to perform aspects discussed herein, dataset integration software 527, data processing software 529 (which may take the form of plugins), and other applications 529. Control logic 525 may be incorporated in and may be a part of dataset processing software 527. In other embodiments, computing device 501 may include two or more of any and/or all of these components (e.g., two or more processors, two or more memories, etc.) and/or other components and/or subsystems not illustrated here.

Devices 505, 507, 509 may have similar or different architecture as described with respect to computing device 501. Those of skill in the art will appreciate that the functionality of computing device 501 (or device 505, 507, 509) as described herein may be spread across multiple data processing devices, for example, to distribute processing load across multiple computers, to segregate transactions based on geographic location, user access level, quality of service (QoS), etc. For example, devices 501, 505, 507, 509, and others may operate in concert to provide parallel computing features in support of the operation of control logic 525 and/or speech processing software 527.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

Although the subject matter has been described in language specific to structural features and/or methodological acts, it is to be understood that the subject matter defined in any claim is not necessarily limited to the specific features or acts described above. Rather, the specific features and acts described above are disclosed as example forms of implementing any claim or any of the appended claims.

We claim:

1. A method comprising:
receiving a notification that a dataset is to be integrated into a computing environment;
generating, based on the notification, a script that causes integration of the dataset;
executing, by a computing platform, the script; and
based on execution of the script:
retrieving, by the computing platform, a data flow descriptor for the dataset, wherein the data flow descriptor indicates one or more associations between the dataset and one or more of a plurality of data storage services and/or data storage devices;
based on the data flow descriptor, determining, by the computing platform, one or more data processes that integrate the dataset into the computing environment; and
performing, by the computing platform and as part of integrating the dataset into the computing environment, the one or more data processes.

2. The method of claim 1, further comprising:
configuring, within the computing environment, a data storage service or a data storage device;
receiving data that includes code for performing a first data process that is associated with the data storage service or the data storage device;
configuring, based on the data, a plugin to data integration software, wherein the plugin enables performance of the first data process; and
wherein performing the one or more data processes includes performing the first data process by executing the code via the plugin.

3. The method of claim 2, wherein the code comprises a class associated with an object-oriented programming language, wherein the one or more associations include a first association, wherein the first association indicates the class, and wherein the first association includes an indication of information associated with the dataset that will be passed as parameters to the class.

4. The method of claim 2, wherein configuring the data storage service or the data storage device includes updating one of the plurality of data storage services and/or data storage devices.

5. The method of claim 2, wherein configuring the data storage service or the data storage device includes adding the data storage service or add the data storage device to the plurality of data storage services and/or data storage devices.

6. The method of claim 4, wherein the data flow descriptor is formatted in JavaScript Object Notation (JSON).

7. The method of claim 1, further comprising:
based on execution of the script:
retrieving, by the computing platform and from a metadata registry, metadata associated with the dataset, wherein the metadata indicates a format of the dataset;
validating, based on the format of the dataset, the dataset; and
proceeding to perform the data processes based on the validating.

8. The method of claim 7, wherein the format of the dataset comprises one or more of a number of columns for the dataset, a length of the dataset, and a type of the dataset.

9. The method of claim 1, wherein the data flow descriptor includes information indicating an identifier of the dataset.

10. The method of claim 1, wherein the data flow descriptor includes information indicating the metadata or information indicating the metadata registry.

11. The method of claim 1, wherein the dataset comprises loan servicing data or call record data.

12. The method of claim 1, wherein the script comprises an identifier for the dataset and location information indicating a storage location of the dataset.

13. The method of claim 12, wherein retrieving the metadata is performed based on the identifier for the dataset and the location information.

14. The method of claim 1, wherein the one or more data processes include a first data process with a structured data processing service, and wherein the one or more data processes include a second data process with a data repository or a database service.

15. The method of claim 1, wherein the one or more data processes include a first data process with a data quality service, and wherein the one or more data processes include a second data process with a data repository or a database service.

16. The method of claim 1, wherein the one or more data processes includes two or more data processes, and wherein the method further comprises:
determining an order in which the two or more data processes are to be performed, and wherein the two or more data processes are performed in accordance with the order.

17. One or more non-transitory media storing instructions that, when executed by one or more processors, cause the one or more processors to perform steps comprising:
receiving a notification that a dataset has been stored and is to be integrated into a computing environment;
generating, based on the notification, a script that causes integration of the dataset into computing environment;
executing, by a computing platform, the script; and
based on execution of the script:
retrieving, by the computing platform, a data flow descriptor for the dataset, wherein the data flow descriptor indicates one or more associations between the dataset and one or more of a plurality of data storage services and/or data storage devices, and wherein the data flow descriptor is authored by a user;
based on the data flow descriptor, determining, by the computing platform, two or more data processes that integrate the dataset into the computing environment; and
performing, by the computing platform, the two or more data processes, wherein the two or more data processes include a first data process with a data mapping service or a data enhancement service, and wherein the two or more data processes include a second data process with a data repository or a database service.

18. The one or more non-transitory media of claim 17, wherein the steps further comprise:
configuring, within the computing environment, a data storage service or a data storage device;
receiving data that includes code for performing a first data process that is associated with the data storage service or the data storage device;
configuring, based on the data, a plugin to data integration software, wherein the plugin enables performance of the first data process; and
wherein performing the one or more data processes includes performing the first data process by executing the code via the plugin.

19. The one or more non-transitory media of claim 17, wherein the steps further comprise:
based on execution of the script:
retrieving, by the computing platform and from a metadata registry, metadata associated with the dataset, wherein the metadata indicates a format of the dataset;
validating, based on the format of the dataset, the dataset by determining that the dataset is in accordance with one or more of the following: a number of columns indicated by the format of the dataset, a length of the dataset indicated by the format of the data, or a type of the dataset indicated by the format of the data; and
proceeding to perform the one or more data processes based on the validating.

20. A system comprising:
a database configured to store datasets for integration into a computing environment;
a computing device configured to operate as a metadata registry; and
a computing platform;
wherein the computing platform comprises:
one or more processors; and
memory storing instructions that, when executed by the one or more processors, cause the computing platform to perform steps comprising:
receiving a notification that the dataset is to be integrated into the computing environment;
generating, based on the notification, a script that causes integration of the dataset into the computing environment, wherein the script comprises an identifier for the dataset and location information indicating a storage location of the dataset;
executing the script; and
based on execution of the script:
retrieving a data flow descriptor for the dataset, wherein the data flow descriptor indicates one or more associations between the dataset and the two or more components of the computing environment, wherein the data flow descriptor is authored by a user and is formatted in JavaScript Object Notation (JSON), and wherein the one or more associations between the dataset and the two or more components of the computing environment comprise a first association between the dataset and a first component of the two or more components, and a second association between the dataset and a second component of the two or more components;
retrieving, from the metadata registry, metadata associated with the dataset, wherein the metadata indicates a format of the dataset;
validating, based on the format of the dataset, the dataset by determining that the dataset is in accordance with one or more of the following: a number of columns indicated by the format of the dataset, a length of the dataset indicated by the format of the data, or a type of the dataset indicated by the format of the data;
based on the data flow descriptor, determining two or more data processes that integrate the dataset into the computing environment;
determining an order in which the two or more data processes are to be performed; and
performing, based on the order, the two or more data processes by performing a first data process with the first component and a second data process with the second component.
